(19) United States
(12) Patent Application Publication
(10) Pub. No.: US 2015/0178795 A1
(43) Pub. Date: Jun. 25, 2015

(54) PERFORMING AUTOMATED APPRAISALS WITH AUTOMATIC DETECTION AND REMEDIATION OF SITUATIONS INVOLVING FAULTY CHARACTERISTICS

(71) Applicant: Fannie Mae, Washington, DC (US)

(72) Inventors: Megan C. Berry, Rockville, MD (US); Felix G. Meale, North Bethesda, MD (US); Eric Rosenblatt, Derwood, MD (US); Jesse Staal, Arlington, VA (US); Angela Tseng, Germantown, MD (US)

(73) Assignee: Fannie Mae, Washington, DC (US)

(21) Appl. No.: 14/139,167

(22) Filed: Dec. 23, 2013

(51) Int. Cl. G06Q 30/02

(52) U.S. Cl. CPC G06Q 30/0278

(57) ABSTRACT

Performing automated appraisals with automatic detection and remediation of situations involving faulty characteristics is disclosed. Property information characteristics are extracted from properties listed on electronic appraisals. For a subject property, faulty characteristics include the absence of characteristics, or errors in characteristics. Such faulty characteristics are those that would cause an automated appraisal of the given property to be invalid or unsuitable. In response to the detection of faulty characteristics, interfaces may solicit input addressing the faulty characteristic and upon remediation indicate a clean and complete characteristic set. Thereafter, automated appraisal of the subject property based on the clean characteristic set is initiated to provide an automated valuation of the subject property.

### BACKGROUND

Databases store voluminous amounts of electronic appraisals, which include property information for real properties. The electronic appraisals may in turn be utilized as sources to populate the fields of an identified real property with property information so that a reviewer may execute an automatic appraisal.

However, it is often the case that some of these electronic appraisals are missing property information. Further, property information of different electronic appraisals related to a same real property may be inconsistent. Missing or inconsistent property information may result from mistakes during an appraiser's inspection of the real property, inaccurately entered property information, physical changes to the subject property over time, etc.

Thus, when the reviewer attempts to execute the automatic appraisal of the identified real property and the electronic appraisals that are used as sources of property information for that property include missing or inconsistent property information, the reviewer may receive an error message without any indication as to why the error message was received. Thus, it may be prudent to provide a system and method for detecting missing or inconsistent property information within the electronic appraisals and providing the reviewer with the opportunity to complete or alter that property information prior the automatic appraisal.

### SUMMARY OF THE INVENTION

In one example, this application describes performing automated appraisals with automatic detection and remediation of situations involving faulty characteristics. Property information characteristics are extracted from properties listed on electronic appraisals. For a subject property, faulty characteristics include the absence of characteristics, or errors in characteristics. Such faulty characteristics are those that would cause an automated appraisal of the given property to be invalid or unsuitable. In response to the detection of faulty characteristics, interfaces may solicit input addressing the faulty characteristic and upon remediation indicate a clean and complete characteristic set. Thereafter, automated appraisal of the subject property based on the clean characteristic set is initiated to provide an automated valuation of the subject property.

### BRIEF DESCRIPTION OF THE DRAWINGS

FIGS. 1A-B illustrate an exemplary scheme in which computing devices operate;

FIG. 2 illustrates an exemplary schematic of a characteristic entry application;

FIG. 3 illustrates an exemplary interface generated by a characteristic entry application; and

FIG. 4 illustrates an exemplary process flow of an operation of a characteristic entry application.

### DETAILED DESCRIPTION

A system and method provides automatically appraising a subject property based on inputs received through an interface that is prompted in response to detecting missing or inconsistent property information or characteristics within electronic appraisals associated with the subject property.

For example, the system and method via a characteristic entry application may, upon loading a subject property, detect within electronic appraisals associated with the subject property faulty characteristics (e.g., missing or inconsistent characteristics) that prevent an error free automatic appraisal of the subject property. The characteristic entry application may then prompt an interface that enables the receipt of inputs, which complete and/or alter the faulty characteristics and produce a clean characteristic set. Then, the characteristic entry application may execute an automatic appraisal of the subject property based on the clean characteristic set, which includes the faulty characteristics that have been addressed by the first input and the characteristics that were unaltered by the input, to generate a valuation for the subject property. Thus, the system and method via the characteristic entry application may enable the evaluation of a subject property where missing or inconsistent characteristics would otherwise cause error messages and/or the automatic appraisal to fail.

An appraisal (e.g., a real estate appraisal, property valuation, or land valuation), in general, may be a process of valuing real property (i.e., a subject property), where the value sought is a market value. The appraisal may be recorded on a form (i.e., appraisal form), an example of which may be a uniform residential appraisal report form. Different appraisal approaches may be employed by the appraisal to estimate the market value (i.e., valuation) of a subject property, such as a sales comparison approach, a cost approach and an income approach, and the appraisal approach and the resulting valuation may be recorded on the appraisal form.

An appraisal form may provide multiple sections with multiple data fields, each of which may memorialize characteristics that contribute to the valuation of the subject property. The appraisal form may be stored on a non-transitory computer readable medium as an electronic appraisal, which may be identified by an identifier, such as a physical address of the subject property, identification number, and/or other information unique to the electronic appraisal.

A subject property is a real property that is being analyzed by a reviewer (e.g., a user operating the characteristic entry application). A subject property may have a plurality of associated electronic appraisals, each of which may provide characteristics for that subject property during an automatic appraisal. These characteristics are utilized to execute an automatic appraisal of the subject property.

Thus, an automatic appraisal of the subject property is a process performed by the characteristic entry application that utilizes property information or characteristics within electronic appraisals associated with the subject property to provide a valuation for the subject property.

In one example, this application describes performing automated appraisals with automatic detection and remediation of situations involving faulty characteristics. Property information characteristics are extracted from properties listed on electronic appraisals. For a subject property, faulty characteristics include the absence of characteristics, or errors in characteristics. Such faulty characteristics are those that would cause an automated appraisal of the given property to be invalid or unsuitable. In response to the detection of faulty characteristics, interfaces may solicit input addressing the faulty characteristic and upon remediation indicate a clean and complete characteristic set. Thereafter, automated appraisal of the subject property based on the clean characteristic set is initiated to provide an automated valuation of the subject property.

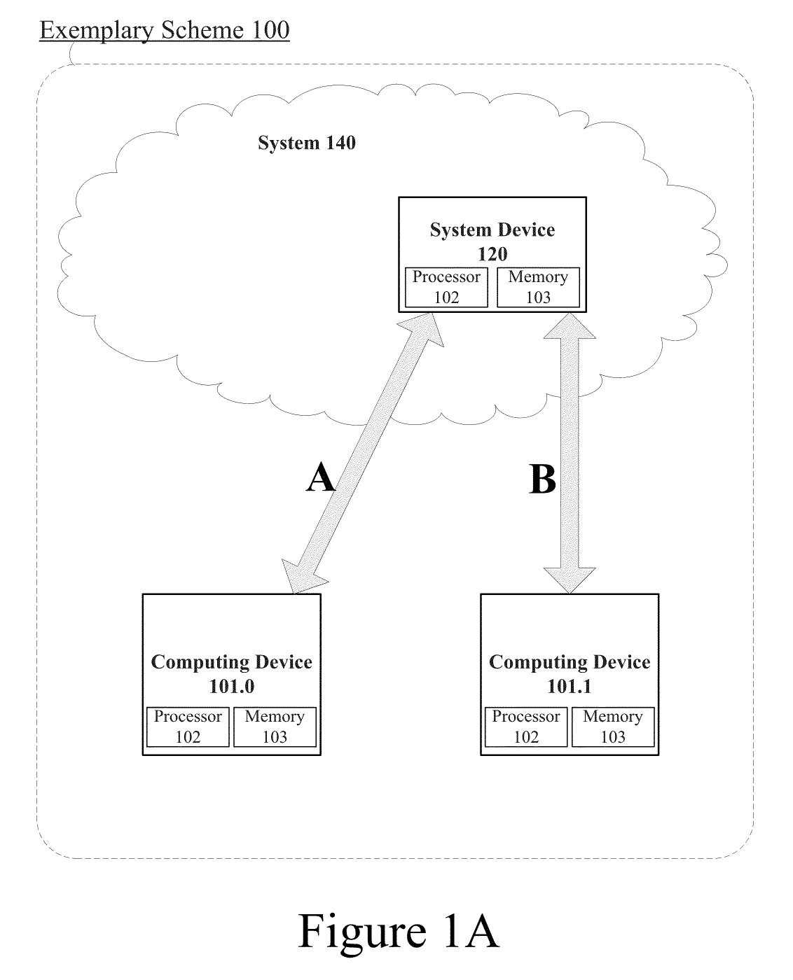

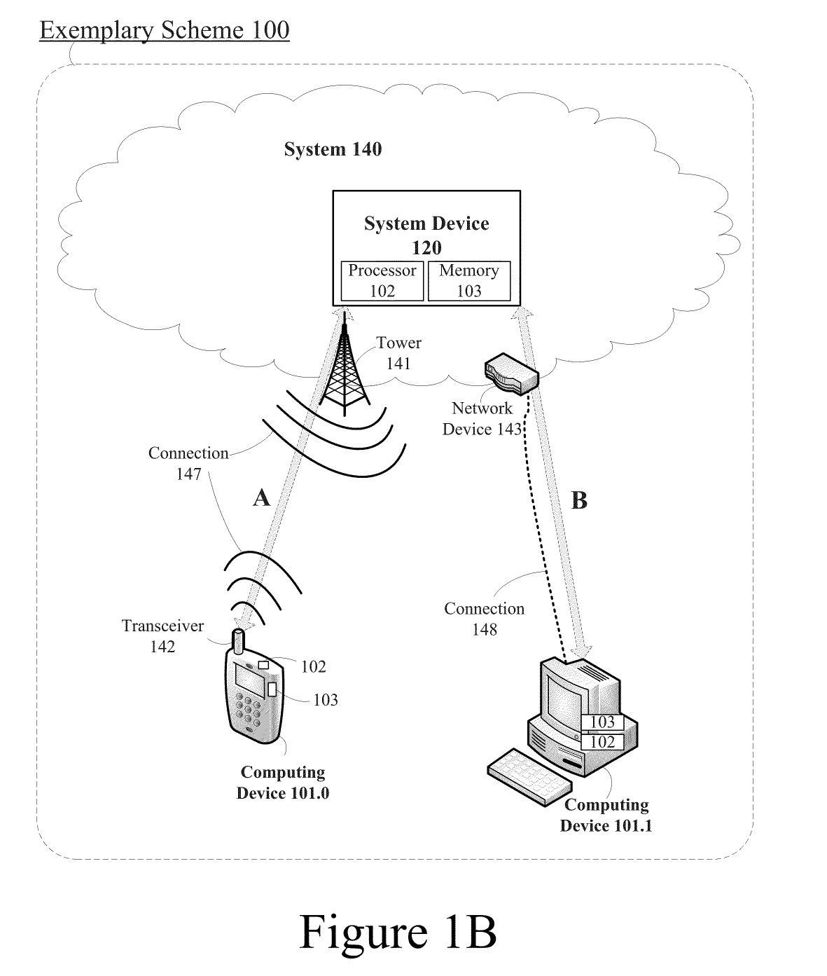

FIG. 1A illustrates an exemplary scheme 100 having computing devices 101, which include processors 102 and memories 130. Further, FIG. 1A illustrates a system device 120, which also includes a processor 102 and a memory 130, within a system 140 that communicates A, B with computing devices 101 to accumulate electronic appraisals and analyze subject properties.

For example, the system device 120 may communicate A with the computing device 101.0 to receive and store an electronic appraisal. The electronic appraisal may be generated via the computing device 101.0 by an appraiser (e.g., a user physically inspecting a subject property). The electronic appraisal may include a set of data fields, the set comprising a year the subject property was built, a lot size of the subject property, a gross living area (GLA) of the subject property, a number of bedrooms in the subject property, and a number of bathrooms in the subject property. Each of the data field may store characteristics (e.g., property information) entered by the appraiser via an interface presented by the computing device 101.0 based on the inspection of the subject property.

Further, the system device 120 may communicate B with the computing device 101.1 to receive inputs that direct the system device 120 to retrieve and analyze a subject property. The system device 120 may receive an instruction from a reviewer of the computing device 101.1 that identifies the subject property and directs the system device 120 to execute an automatic appraisal of the identified subject property. The system device 120 may then acquire a plurality of electronic appraisals associated with the identified subject property, where each of the plurality of electronic appraisals includes a set of data fields, and each of the data fields stores a characteristic corresponding to the subject property. The system device 120 may next extract the characteristics from the plurality of appraisals by accumulating and grouping the characteristics according to respective data fields (into data field groups) and detect whether any of the characteristics of the plurality of electronic appraisals are missing or inconsistent (e.g., faulty) across the same data field. When at least one of the characteristics is detected as being faulty, the system device 120 may prompt the presentation of an interface that provides the reviewer with the opportunity to input (e.g., complete and/or alter) characteristics of the identified subject property prior the automatic appraisal. Based on the reviewer input a clean characteristic set may be generated by the system device 120. The system device 120, in turn, may execute an automatic appraisal of the identified subject property to generate a valuation, which is communicated B to the computing device 101.1 for presentation to the reviewer.

The items of the exemplary scheme 100 will now be further described with references to FIG. 1B. FIG. 1B illustrates exemplary infrastructure components that support the communication operations between the devices 101, 120 of FIG. 1A (note that items that have been previously discussed may be utilized to denote the same or similar items in subsequent Figures). The exemplary infrastructure components may include a tower 141, a transceiver 142, a network device 143, and connections 147, 148. FIG. 1B also includes alternative representations for the computing devices 101, to illustrate different exemplary configurations of the exemplary scheme 100, which are further described below.

The exemplary scheme 100 and devices 101, 120 may be any computing system and/or device that includes a processor and a memory (e.g. 102 and 103, respectively). Computing systems and/or devices generally include computer-executable instructions, where the instructions may be executable by one or more computing devices such as those listed below. Computer-executable instructions may be compiled or interpreted from computer programs created using a variety of programming languages and/or technologies, including, without limitation, and either alone or in combination, Java™, C, C++, Visual Basic, Java Script, Perl, etc. The exemplary scheme 100 and items therein (e.g., devices 101, 120) may take many different forms and include multiple and/or alternate components and facilities, as illustrated in the Figures further described below. While exemplary systems, devices, modules, and sub-modules are shown in the Figures, the exemplary components illustrated in the Figures are not intended to be limiting. Indeed, additional or alternative components and/or implementations may be used, and thus the above communication operation examples should not be construed as limiting.

In general, computing systems and/or devices (e.g., the exemplary scheme 100 and the devices 101, 120) may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing systems and/or devices include, without limitation, cell phones, smart-phones (e.g., the computing device 101.0), super-phones, tablet computers, next generation portable devices, mobile printers, handheld computers, secure voice communication equipment, or some other computing system and/or device. Alternatively, computing systems and/or devices may also be a computer workstation, a server, a desktop (e.g., the computing device 101.0), a notebook, or a laptop.

Further, the processor or the microprocessor (e.g., processors 102) of computing systems and/or devices receives instructions from the memory (e.g., memories 103) and executes these instructions, thereby performing one or more processes, including one or more of the processes described herein (e.g., extracting characteristics from a plurality of electronic appraisals associated with an identified subject property, where the characteristics are property information corresponding to the identified subject property; detecting a faulty characteristic based on whether at least one of the characteristics would cause an automatic appraisal to fail; prompting an interface in response to detecting the faulty characteristic; receiving through the interface a first input addressing the faulty characteristic to produce a clean characteristic set; executing the automatic appraisal of the subject property based on the clean characteristic set; and providing a valuation of the subject property resulting from the automatic appraisal, etc.). Such instructions and other data may be stored and transmitted using a variety of computer-readable mediums (e.g., memory 103).

A processor 102 may include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the processor 102 may be any one of, but not limited to single, dual, triple, or quad core processors (on one single chip), graphics processing units, visual processing units, and virtual processors.

A memory 103 may be, in general, any computer-readable medium (also referred to as a processor-readable medium) that may include any non-transitory (e.g., tangible) medium that participates in providing data (e.g., instructions) that may be read by a computer (e.g., by processors 102 of devices 101, 120). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, the elements of the devices 101, 120 may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the operations described herein.

The computing devices 101 may generally be any electronic hardware that includes a processor 102 and a memory 103 and is capable of receiving and processing inputs (e.g., user entered data that completes or alters faulty characteristics that are missing or inconsistent) and sending electronic data transfers (e.g., communications A, B) to the system 140 that include those inputs.

The computing devices 101 may further, include a display, support interfaces, and/or communicate within the exemplary scheme 100. A display is an output device for presentation of information in visual or tactile form, such as interfaces or web portals. Examples of display may include, without limitation, cathode ray tube display, light-emitting diode display, electroluminescent display, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, and the like. Thus, a display of any computing device 101 may present interfaces or a web portal to a user, such that the user may interact with and receive information from other computing devices 101 or the system device 120.

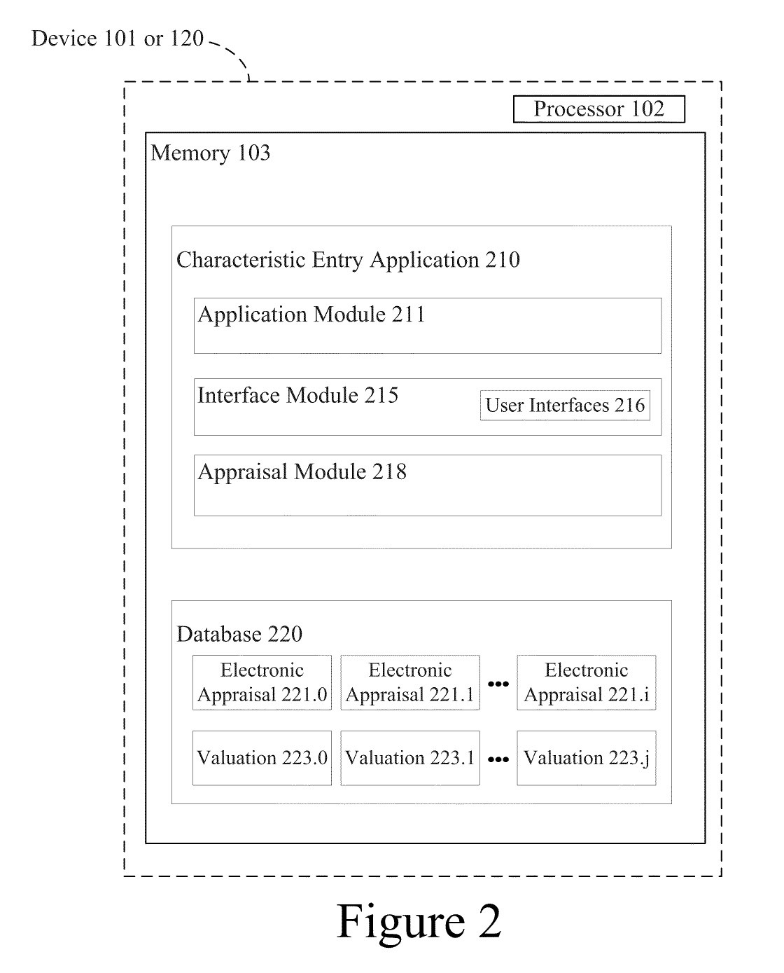

The computing devices 101 may further utilize the processor 102 to operate a characteristic entry application (e.g., characteristic entry application 210 of FIG. 2 described below) to generate interfaces (e.g., user interfaces 216 of FIG. 2) on the display to receive inputs, generate records (e.g., electronic appraisals 221 and valuations 223 of FIG. 2) based on those inputs, and process electronic data transfers (e.g., communications A, B) that include those inputs.

The system device 120 may also be any hardware that includes a processor 102 and a memory 103 and automatically appraises a subject property based on inputs received through an interface that is prompted in response to detecting faulty characteristics within electronic appraisals associated with the subject property. Further, the system device 120 may be a server.

In general, a server may be any computing system and/or device (as described above) acting as databases, data repositories or other data stores that includes any type of data source and/or file system that manages and records electronic appraisals, characteristic alterations, automatic appraisals, valuations, electronic data transfers, etc. For instance, data sources may include data management client, along with licenses (e.g., a license that permits control and access of electronic appraisals by the computing devices 101) relating to a data management access and/or configurations. Thus, a device management client may include executable instructions that manage the communications (e.g., communication A, B) with computing devices 101 by setting configurations and diagnostics based on a particular protocol.

Further, databases, data repositories or other data stores (e.g., database 220 of FIG. 2 described below) described herein may generally include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within or external to a computing system and/or device (e.g., the devices 101, 120) employing a computer operating system such as one of those mentioned above, and/or accessed via a network (e.g., a system 140) or connection in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

A system 140 may be a network that provides the infrastructure through which the devices 101, 120 communicate. In general, a network (e.g., the system 140) may be a collection of computers and other hardware to provide infrastructure to establish virtual connections and carry communications. For instance, a network may be an infrastructure that generally includes edge, distribution, and core devices (e.g., tower 141 or network device 143) and enables a path (e.g., connections 147, 148) for the exchange of information between different devices and systems (e.g., between the devices 101, 120). Further, a network may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications. The system 140 is representative, and thus while a single cloud illustrates the system 140, this illustration may represent a single network, a combination of different networks components and technologies, and/or a plurality of networks, as described above.

The tower 141 may be a tall structure designed to support antennas or aerials for telecommunications amongst the exemplary scheme 100. The tower 141 may enable the connection 147 that carries signals to or from the system 140, such as the communication A between the tower 141 of the system 140 and the transceiver 142 of the computing device 101.

The transceiver 142 may be any connector used for digital or analog signal transfers. For instance, the transceiver 142 may be any antenna technology, such as cellular, Wi-Fi, or the like, that implements a wireless exchange of data by converting propagating electromagnetic waves to and from conducted electrical signals. Further, the transceiver 142 may be an antenna technology that implements Wi-Fi, near field communication, Bluetooth®, or the like, which is used to exchange data wirelessly using radio waves over a shortwave radio range or network that enables direct communication.

The network device 143 may be a computing system and/or device, as described above, that is a gateway between connection 148 and the system 140 to complete a communication path between the computing device 101.1 and the system device 120.

The connections 147, 148 may be wired or wireless connections between two endpoints (devices or systems) that carry electrical signals that facilitate virtual connections. Examples of connections 147, 148 may be any transmission media including radio waves, metal wire, fiber optics, and the like. Virtual connections are comprised of the protocol infrastructure that enables communication (e.g., communications A, B) to and from devices 101, 120. Thus, connection 147 may be a wireless connection between the tower 141 and the transceiver 142, and connection 148 may be a wired connection between the computing device 101.1 and network device 143. Further, the combination of connections 147, 148 support the virtual connections of the exemplary scheme 100, and therefore, any device 101, 120 may communicate with another device 101, 120 based on a need of the exemplary scheme 100.

The characteristic entry application will now be described with reference to the exemplary schematic of FIG. 2. FIG. 2 illustrates a characteristic entry application 210 and a database 220 stored on a memory 130 of any of the devices 101,120 (as illustrated by the dashed-box). The characteristic entry application 210 includes an application module 211, an interface module 215 that generates user interfaces 216, and an appraisal module 218. Further, the system device 120 may store and manage records, such as electronic appraisals 221 and valuations 223.

Although one modular breakdown of the characteristic entry application 210 is offered, it should be understood that the same functionality may be provided using fewer, greater, or differently named modules. Further, although it is not shown, the interface module 215 and the application module 218 may be integrated with any of the above named modules.

A single computing device may be independently configured to include the entire operability of the characteristic entry application 210, as illustrated in FIG. 2. Thus, the characteristic entry application 210 may generally be operated independently by one of the devices 101, 120. For instance, based on an input received via a user interface 216 of the interface module 215, the characteristic entry application 210 may utilize the application and management modules 211, 218 to generate an electronic appraisal; load characteristics of a subject property according to associated electronic appraisals (including the recently generated electronic appraisal), detecting faulty characteristics amongst the associated electronic appraisals, prompting another user interface 216 for receiving inputs that address (e.g., complete or alter) the faulty characteristics and produce a clean characteristic set, executer an automatic appraisal of the subject property based on the clean characteristic set, provide a valuation of the subject property based on the automatic appraisal. The characteristic entry application 210 may memorialize the electronic and/or automatic appraisals respectively in the electronic appraisals 221 of the database 220, where each instance of the electronic appraisals 221 stores property information (e.g., characteristics particular to the subject property at the time of creation of the electronic or automatic appraisals) in its respective set of data fields. The characteristic entry application 210 may further generate and accumulate valuations 223 to support analytics of a subject property.

As an alternative example, the operability of the characteristic entry application 210 may be divided between the devices 101, 120, where modules 211, 215, 218 may be located separately or duplicated on different devices 101, 120 and accessed through connections 147, 148 via distributed computing, such that the operability is provided for, shared, and relied upon by other devices 101, 120. Thus, the characteristic entry application 210 may generally be divided between the devices 101, 120, where modules 211, 215, 218 may be duplicated on different devices and accessed through connections 147, 148. For example, an appraiser, who is physically inspecting a subject property, may utilize the appraisal module 218 of the computing device 101.0 to generate an electronic appraisal that includes a physical address of the subject property. The system device 120 and the computing device 101.0 may communicate A via their respective application modules 211 to transfer the electronic appraisal, which is stored by the system device 120. The electronic appraisal may comprises a set of data fields, where each of the data fields stores characteristics (e.g., property information) entered by the appraiser via a user interface 216 generated by the interface module 215 of the computing device 101.0 based on the appraisers inspection of the subject property.

Further, the system device 120 and the computing device 101.1 may communicate B via their respective application modules 211 to transfer a request by a reviewer that identifies by the physical address of the subject property to execute an automatic appraisal, from the computing device 101.1 to the system device 120. The system device 120 via the appraisal module 218 in turn acquires a plurality of electronic appraisals 221 from the database 220 that includes the physical address, extracts and groups/compiles characteristics (into data field groups) from the plurality of electronic appraisals, and scans for faulty characteristics regarding the subject property identified by the physical address. When faulty characteristics are detected, the system device 120 communicates B a notification to the computing device 101.1 that prompts the generation of another user interface 216 by the interface module 215 of the computing device 101.1. The reviewer may then through the user interface 216 communicate inputs to the system device 120 that address (e.g., complete and/or alter) the characteristics of the subject property and produce a clean characteristic set. Based on the clean characteristic set, the system device 120 may execute the automatic appraisal of the subject property to generate a valuation for the subject property.

The application module 211 may include a set of executable instructions configured to facilitate communication between the modules of the characteristic entry application 210 and hardware/software components external to the characteristic entry application 210, including the devices 101, 120. That is, the application module 211 may be configured to communicate directly with other applications, modules, models, devices, systems, and other sources through both physical and virtual interfaces. Further, the application module 211 may include executable instructions and specifications for routines, data structures, object classes, and variables that receive, package, present, and transfer data through a connections 147,148 or through a system 140, as further described below. For example, the application module 211 may be configured to receive inputs from the interface module 215 or sources external to the devices 101, 120 and forward the inputs to the appraisal module 218 for processing.

The application module 211 may also manage the dispatching and receipt of information along with integrating the characteristic entry application 210 with other applications and drivers, as needed per operating system. A driver is a computer routine that controls a particular physical component of device or a peripheral (e.g., a printer, display, or the like) attached to the device. Thus, the application module 211 may manage and translate input/output requests into data processing instructions for the central processing unit (e.g., CPU 102) and may include a set of executable instructions that itemizes and implements the data structures, object classes, and variables that interact with the drivers to operate physical components and that launch routines and/or programs (e.g., send and receive instructions/information to and from the computing device 101 and/or the system device 120).

The interface module 215 may include a set of executable instructions for generating and managing user interfaces 216, which receive inputs and present information. The inputs received by the user interfaces 216 may generally be communicated by interface module 215 to the application module 211, which in turn forwards the inputs to the appraisal module 218 for processing.

The interface module 215 may also commandeer or utilize interface formatting local to the device in which the characteristic entry application 210 is stored thereon (e.g., appropriating interfaces of the devices 101, 120). The interface module 215 may also provide remote interface formatting for a device in which only a portion of the characteristic entry application 210 is stored thereon (e.g., providing web portal interfaces for computing devices 101 through which the system device 120 may provide information and receive inputs). The interface module 215 may thus generate or utilize local, terminal, web-based, and mobile interfaces and any similar interface that presents and receives information relative to the devices 101, 120.

The user interfaces 216 may include any presentation of space through a display (as described above), whether graphic or otherwise, where interaction between a user and the characteristic entry application 210 occurs. The user interfaces 216 may receive inputs indicating user selections and/or user instructions, along with characteristics, with respect to generating electronic appraisals; completing and/or altering characteristics; and executing an automatic appraisal of a subject property.

The user interfaces 216 may also include any presentation of information through notifications such as banners, icons, badges, alerts, sounds, text, or any combinations thereof. A banner may be a media or drop-down menu that extends from a top portion of an interface, a sub-interface, and/or display and that may include text, badges, and animated symbols. An icon and/or a badge may be a number or symbol that signals a link, an event, or a number of events. An alert may be a pop-up window that may be oriented within the display (e.g., centered) and that may include text, badges, and animated symbols.

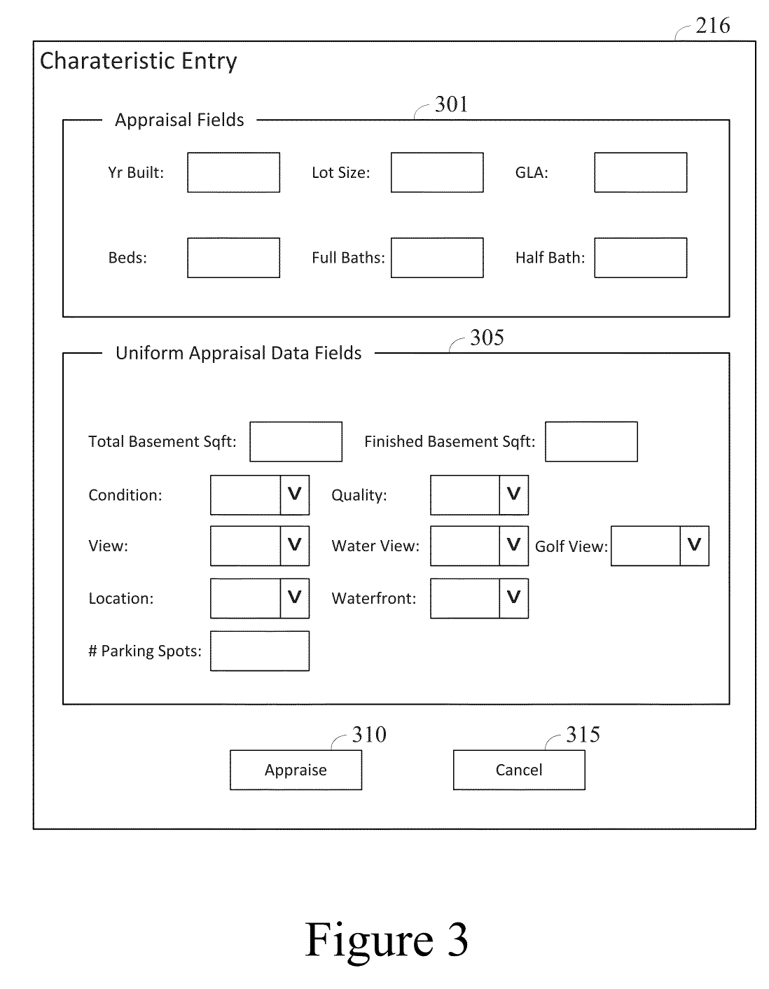

Thus, the interface module 215 may further generate new and unique user interfaces 216 particular to the characteristic entry application 210. One example of a user interface 216 may include the exemplary user interface 216 of FIG. 3.

FIG. 3 illustrates an exemplary user interface 216 referred to as a ‘Characteristic Entry’ interface generated by the characteristic entry application 210. The ‘Characteristic Entry’ interface, as illustrated, may include data entry fields grouped into subsets 301, 305, an appraisal button 310, and a cancel button 315. A data entry field may be a mechanism for receiving input and may correspond to one of the set of data fields of an electronic appraisal and/or subject property such that the characteristics of a loaded subject property may be completed and/or altered by inputs.

A first subset 301 (the ‘Appraisal Field’ subset 301) includes the data entry fields of a year the subject property was built (‘Yr Built’ field), a lot size of the subject property (‘Lot Size’ field), a GLA of the subject property (‘GLA’ field), a number of bedrooms in the subject property (‘Beds’ field), a number of full bathrooms in the subject property (‘Full Bath’ field), and a number of half bathrooms in the subject property (‘Half Bath’ field). A second subset 305 (the ‘Uniform Appraisal Data Field’ subset 305) includes the data entry fields of a total square footage of a basement of the subject property (‘Total Basement Sqft’ field), a condition of the subject property (‘Condition’ field), a quality of the subject property (‘Quality’ field), a view from the subject property (‘View’ field), an indication of the location of the subject property (‘Location’ field), and a number of parking spots related to the subject property (# Parking Spots' field). Data entry fields may be text and/or menu entry fields. For example, the ‘Yr Built’ field may be a text entry field that permits the entry of a four digit number identifying a year. Similarly, the ‘Lot Size,’ ‘GLA,’ ‘Beds,’ ‘Full Bath,’ ‘Half Bath,’ ‘Total Basement Sqft,’ and ‘# Parking Spots’ fields may also be text entry fields that permit the entry of numerical values identifying property information of the subject property. The ‘Condition,’ ‘Quality’, ‘View,’ and ‘Location’ fields may be menu entry fields that permit the selection of a list of characteristics (e.g., beneficial, neutral, or adverse). Thus, a missing characteristic may be when a data field group does not include any characteristic, such as if each ‘Yr Built’ field for all the electronic appraisals associated with a subject property does not include a characteristic (e.g., a four digit number representing a year). An inconsistent characteristic may be when a data field group does not include matching characteristics, such as if at least two different electronic appraisals associated with a subject property include different characteristics for the ‘Yr Built’ field (e.g., a first electronic appraisal include ‘1975,’ while a second electronic appraisal includes ‘1983’).

Further, a primary data entry field may be linked to at least one secondary data entry field, such as when the primary ‘Total Basement Sqft’ field is linked to a secondary data entry field regarding a total square footage of a finished portion of a basement (‘Finished Basement Sqft’ field). Similarly, the primary ‘View’ field may be linked to secondary data entry fields regarding whether the subject property has a view of water (‘Water View’ field) or a golf course (‘Golf View’ field), and the primary ‘Location’ field may be linked to a secondary data entry field regarding whether the subject property is located on a waterfront (‘Waterfront’ field). In turn, the ‘Water View,’ ‘Golf View,’ and ‘Waterfront’ fields may be menu entry fields that permit the selection of a list of sub-characteristics (e.g., yes or no). Thus, it may be the case that when a primary data entry field receives a text entry or menu selection of a characteristic, a reviewer may be permitted to further interact with a secondary data entry field. For example, if a value greater than zero is entered as a characteristic in the primary ‘Total Basement Sqft’ field, then a reviewer may have the option to enter a numerical value as a characteristic in the linked secondary ‘Finished Basement Sqft’ field; if ‘beneficial’ is selected as a characteristic from the primary ‘View’ field, then a reviewer may have the option to select as characteristics ‘yes’ or ‘no’ under the linked secondary ‘Water View’ and ‘Golf View’ fields; and if ‘beneficial’ is selected as a characteristic from the primary ‘Location’ field, then a reviewer may have the option to select as a characteristic ‘yes’ or ‘no’ under the linked secondary ‘Waterfront” field.

An appraisal button 310 may be a mechanism for receiving user consent and, upon selection, may trigger the appraisal module 218 to execute an automatic appraisal of a subject property. For instance, in response to the selection of the appraisal button 310, the appraisal module 218 may utilize the inputs currently received by the data entry fields of the ‘Characteristic Entry’ interface in conjunction with the unaltered characteristics of the subject property to produce a clean characteristic set. Then the appraisal module 218 may generate a valuation for the subject property based on the clean characteristic set. A cancel button 315 may be a mechanism for receiving user consent to exit the ‘Characteristic Entry’ interface without performing an automatic appraisal.

The appraisal module 218 may include a set of executable instructions configured to receive an identifier; identify, as the identified subject property, a real property to be automatically appraised based on the identifier; acquire the plurality of electronic appraisals associated with the identified subject property; extract characteristics from a plurality of electronic appraisals associated with the identified subject property, where the characteristics are property information corresponding to the identified subject property and where each of the plurality of electronic appraisals includes a set of data fields that stores the characteristic; accumulate and grouping according to respective data fields each characteristic from the plurality of electronic appraisals; detect faulty characteristic based on whether at least one of the groups of characteristics would cause an automatic appraisal to fail; prompt an interface in response to detecting the faulty characteristic; receive through the interface a first input addressing the faulty characteristic to produce a clean characteristic set; execute the automatic appraisal of the subject property based on the clean characteristic set; and provide a valuation of the subject property resulting from the automatic appraisal.

That is, the appraisal module 218 may receive inputs from the interface module 215 through the application module 211 and generate an electronic appraisal 221 memorializing an inspection of a subject property. The appraisal module 218 may also receive inputs from the interface module 215 through the application module 211 and automate an appraisal process to produce a valuation 223 of an identified subject property. The appraisal module 218 may further associate user data, as described below, with electronic appraisals and/or valuations. The appraisal module 218 may complete missing data of existing electronic appraisals by filling in empty data fields with inputs (e.g., characteristics submitted by the user through a user interface 216).

The appraisal module 218 may also enable automatic appraisals (e.g., electronic pseudo appraisals) that concentrate only on the property information that affect large changes in a market value of the subject property. The property information that affect large changes in a market value may include the characteristics associated with the ‘Appraisal Field’ subset 301. Electronic pseudo appraisal may be governed by a predetermined configuration of the characteristic entry application 210, where the predetermined configuration sets a minimum number of characteristics that must be loaded for a subject property so that the electronic pseudo appraisal may proceed without error.

One example of a predetermined configuration may include requiring a clean characteristic set for all the fields of the ‘Appraisal Field’ subset 301. Thus, if a subject property is loaded into the characteristic entry application 210 based on an identifier and there are not enough characteristics amongst the initially loaded characteristics to correctly populate the ‘Appraisal Field’ subset 301, then the appraisal module 218 will not proceed with the automatic appraisal or electronic pseudo appraisal without prompting the user with the ‘Characteristic Entry’ interface. On the other hand, if a subject property is loaded into the characteristic entry application 210 based on an identifier and are faulty characteristics are detected, the appraisal module 218 proceed if at least each of the six data fields of the ‘Appraisal Field’ subset 301 include a clean characteristic set, e.g., regardless of the state of the characteristics in the ‘Uniform Appraisal Data Field’ subset 305. In other words, if the plurality of electronic appraisals associated with the identified subject property do not adequately provide a characteristic for each of the ‘Yr Built,’ ‘Lot Size,’ ‘GLA,’ ‘Beds,’ ‘Full Bath, and ‘Half Bath’ fields, then the appraisal module 218 may automatically prompt the reviewer with the ‘Characteristic Entry’ interface. Thus, the characteristic entry application 210 may invite the reviewer in advance of an automatic appraisal and evaluation of the subject property to input missing property information.

Predetermined configurations may take many different forms and include multiple and/or alternate data field requirements, and the exemplary six data fields of the ‘Appraisal Field’ subset 301 is not intended to be limiting. For instance, a predetermined configuration may, in addition to requiring a characteristic for each of the exemplary six data fields of the ‘Appraisal Field’ subset 301, require that each of the exemplary six data fields of the ‘Appraisal Field’ subset 301 be consistent across a plurality of electronic appraisals. In this case, if a first electronic appraisal for a subject property includes ‘3’ as a characteristic for the ‘Beds’ data field and a second electronic appraisal for that subject property includes ‘4’ as a characteristic for the ‘Beds’ data field, then the appraisal module 218 may automatically prompt the reviewer with the ‘Characteristic Entry’ interface so that the reviewer may view and chose between the inconsistent characteristics of ‘3’ and ‘4.’

Further, another predetermined configuration may, in addition to requiring a characteristic for each of the exemplary six data fields of the ‘Appraisal Field’ subset 301, require that each of the exemplary six data fields of the ‘Appraisal Field’ subset 301 be consistent across a plurality of electronic appraisals for a given time period. Therefore, if all electronic appraisals for a subject property over the most recent five years include inconsistent characteristics for any of the exemplary six data fields of the ‘Appraisal Field’ subset 301, then the appraisal module 218 may automatically prompt the reviewer with the ‘Characteristic Entry’ interface so that the reviewer may view and chose between the inconsistent characteristics.

The appraisal module 218 may further include a heuristic that intelligently identifies faulty characteristics, such that the interruption of an automatic appraisal and prompting of the interface is avoided when patterns of missing and/or inconsistent characteristics are identified. For example, the electronic appraisals for a subject property over the most recent five years may include inconsistent characteristics that are split into two consistent groups. A first group includes electronic appraisals dated within a first period of the five years, where each electronic appraisal has the same values for all six data fields of the ‘Appraisal Field’ subset 301 (e.g., where the characteristics regarding the ‘GLA,’ ‘Beds,’ ‘Full Bath, and ‘Half Bath’ fields are 1500, 2, 1, and 0, respectively). A second group includes electronic appraisals dated within a second period of the five years that does not overlap the first period, where each electronic appraisal has the same values for all six data fields of the ‘Appraisal Field’ subset 301 (e.g., where the characteristics regarding the ‘GLA,’ Beds,’ ‘Full Bath, and ‘Half Bath’ fields are 1700, 3, 1, and 1, respectively). In this case, the heuristic may intelligently identify that the inconsistency is derived from a possible addition to the subject property, as the GLA has increased along with the number of bedrooms and number of half bathrooms.

In addition, the appraisal module 218 may include a set of executable instructions configured to view and edit any electronic appraisal. For instance, when an electronic appraisal is loaded by the characteristic entry application 210, the interface module may provide an icon (e.g., a pencil signaling an edit operation) within the electronic appraisal that when selected prompts a user interface 216 (e.g., the ‘Characteristic Entry’ interface). Thus, a reviewer may directly correct faulty characteristics via the interface module 211 and appraisal module 218 within an electronic appraisal outside of executing an automatic appraisal or electronic pseudo appraisal. In other words, the characteristic entry application 210 enables a user to correct property information on even a current electronic appraisal that has no missing values, by clicking an icon that opens the ‘Characteristic Entry’ interface, with all data fields filled with characteristics, and allows the user to change the characteristics presented.

Therefore, characteristic entry application 210 via the appraisal module 218 may, by editing the data entry fields of the ‘Characteristic Entry’ interface, change anything essential about the property, except for its location, either before executing an automatic appraisal and/or electronic pseudo appraisal or independent thereof.

The system device 120 (and alternatively the computing devices 101), as described above, may include various kinds of mechanisms for storing, providing, accessing, and retrieving various kinds of data, such as electronic appraisals 221 and valuations 223. Electronic appraisals 221 and valuations 223 are different record types that digitally represent real property appraisals and automatic appraisal outputs, respectively. For example, in view of the characteristic entry application 210 facilitating the generation of electronic appraisals, the system device 120 may store and provide access to electronic appraisals 221 that represent the uniform residential appraisal report form and include multiple sections with multiple data fields, each of which may memorialize characteristics that contribute to the valuation of the subject property. Further, the system device 120 may store and provide access to valuations 223 that represent an estimated market value of a subject generated according to an automatic appraisal or electronic pseudo appraisal.

The electronic appraisal 221 and the valuations 221 may also include user data, which may be held by the characteristic entry application 210. User data may include identification information of the individual creating the electronic appraisal 221, inputting characteristics, executing automatic appraisals, etc. The user data may also be stored and based on privileges (e.g., licenses, security right, etc.) enable different users to access and review the information that is associated with the user data.

In addition, the electronic appraisal 221 are illustrated as electronic appraisals 221.0 to 221.i. The notation of ‘i’ indicates the plurality of appraisals stored on the database 220. Similarly, the valuations 223 are illustrated as valuations 223.0 to 221.j and the notation of T indicates the plurality of valuations stored on the database 220.

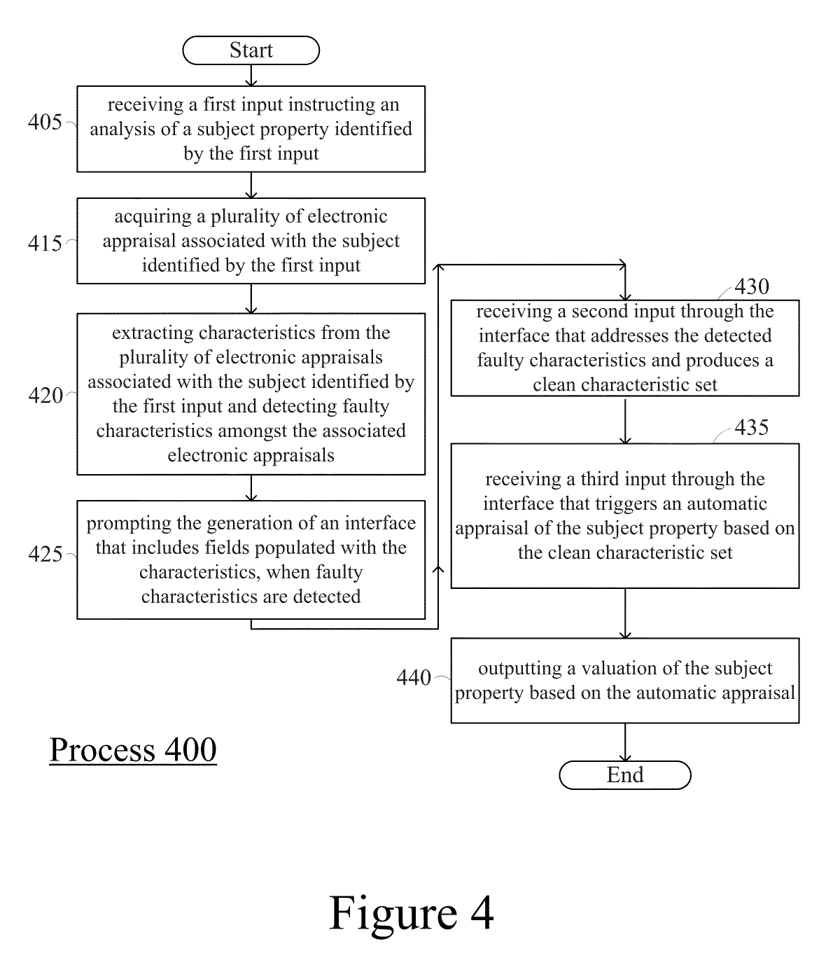

FIG. 4 illustrates an exemplary process flow 400 regarding a characteristic entry application operation. The exemplary process 400 begins by receiving 405 a first input instructing an analysis of a subject property identified by the first input. That is, the characteristic entry application 210 may receive via the user interfaces 216 of the interface module 215 the first input, the first input including an identifier, and utilize the application and management modules 211, 218 to analyze the first input (e.g., identifying, as the identified subject property, a real property to be automatically appraised based on the identifier).

For example, the system device 120 and the computing device 101.1 may communicate B via their respective application modules 211 to transfer a request from a reviewer that identifies by the physical address of the subject property to execute an automatic appraisal, from the computing device 101.1 to the system device 120.

Next, the exemplary process 400 continues by acquiring 415 a plurality of electronic appraisals associated with the subject identified by the first input. That is, the system device 120 via the appraisal module 218 in turn acquires a plurality of electronic appraisals 221 from the database 220 that includes the physical address (e.g., acquiring the plurality of electronic appraisals associated with the identified subject property).

The exemplary process 400 carries on by extracting 420 characteristics from the plurality of electronic appraisals associated with the subject identified by the first input and detecting faulty characteristics amongst the associated electronic appraisals. That is, the system device 120 via the appraisal module 218 may extract and group/compile characteristics from the plurality of electronic appraisals (e.g., since each of the plurality of electronic appraisals includes a set of data fields that stores characteristics particular to the subject property, the appraisal module 218 may extract the characteristics stored by the data fields of each electronic appraisals and group each characteristic according to the data fields in which they match). The appraisal module 218 may then scan each characteristic group for faulty characteristics regarding the subject property identified by the physical address.

The exemplary process 400 continues by prompting 425 the generation of an interface that includes fields populated with the characteristics, when faulty characteristics are detected. For example, the system device 120 communicates B a notification to the computing device 101.1 that prompts the generation of a user interface 216 by the interface module 215 of the computing device 101.1 for addressing the faulty characteristics. The user interface 216 may further highlight the faulty characteristics by a mechanism, such as adding an icon or a border to a data entry field or that includes faulty characteristics. For instance, the ‘Yr Built’ field may be highlighted by an icon when it includes faulty characteristics, as described above, while the remaining fields of the ‘Appraisal Field’ subset 301 are populated with the respective characteristics.

Next, the exemplary process 400 may carry on by receiving 430 a second input through the interface that addresses the detected faulty characteristics and produces a clean characteristic set. That is, the reviewer may then through the user interface 216 enter inputs that address the characteristics of the highlighted data entry fields and the appraisal module 218 utilizes the inputs to generate the clean characteristic set.

The exemplary process 400 may continue by receiving 435 a third input through the interface that triggers an automatic appraisal of the subject property based on the clean characteristic set. Thus, the system device 120 may execute an automatic appraisal of the subject property to generate a valuation for the subject property based on inputs received through the interface.

Then, the exemplary process 400 carries on by outputting 440 a valuation of the subject property based on the automatic appraisal. At this time, the system 120 may memorialize the automatic appraisal in a valuation 223 of the database 220.

Next, the exemplary process flow 400 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Further, for purposes of explanation, numerous details are set forth, such as flowcharts and system configurations, to provide an understanding of one or more embodiments. However, it is and will be apparent to one skilled in the art that these specific details are not required to practice the described.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method for entering at least one input prior to an automatic appraisal of an identified subject property, the method comprising:
extracting, by a processing unit, characteristics from a plurality of electronic appraisals associated with the identified subject property, where the characteristics are property information corresponding to the identified subject property;
detecting, by the processing unit, a faulty characteristic based on whether at least one of the characteristics would cause the automatic appraisal to fail;
prompting, by the processing unit, an interface in response to detecting the faulty characteristic;
receiving, by the processing unit, through the interface a first input addressing the faulty characteristic to produce a clean characteristic set;
executing, by the processing unit, the automatic appraisal of the subject property based on the clean characteristic set; and
providing, by the processing unit, a valuation of the subject property resulting from the automatic appraisal.

2. The method of claim 1, further comprising:
receiving an identifier;
identifying, as the identified subject property, a real property to be automatically appraised based on the identifier; and
acquiring the plurality of electronic appraisals associated with the identified subject property.

3. The method of claim 1, wherein
each of the plurality of electronic appraisals includes a set of data fields,
each of the data fields stores a characteristic corresponding to the subject property,
extracting the characteristics includes accumulating and grouping according to respective data fields each characteristic from the plurality of electronic appraisals, and
the faulty characteristics is a characteristic that is missing from each of the plurality of electronic appraisal across a same data field.

4. The method of claim 1, wherein
the interface includes a set of data entry fields, each of which are configured to receive the at least one input,
one of the data entry fields is a primary data entry field, and
another of the data fields is a secondary data entry field that is linked to the primary data entry field.

5. The method of claim 1, wherein
the clean characteristic set includes the faulty characteristic that has been addressed by the first input and the characteristics that were unaltered by the input.

6. The method of claim 1, wherein
the automatic appraisal is an electronic pseudo appraisal that concentrates on a particular subset of the characteristics.

7. The method of claim 6, wherein
the particular subset of the characteristics is defined by a predetermined configuration that sets a minimum number of characteristic groups that must be extracted for the automatic appraisal to proceed without fail.

8. The method of claim 1, further comprising:
identifying, by a heuristic, a pattern relating to the faulty characteristic;
preventing of the prompting of the interface; and
proceeding with the automatic appraisal.

9. A computer-readable medium tangibly embodying computer-executable instructions for entering at least one input prior to an automatic appraisal of an identified subject property, that when executed by a processor cause the processor to perform operations comprising:
extracting characteristics from a plurality of electronic appraisals associated with the identified subject property, where the characteristics are property information corresponding to the identified subject property;
detecting a faulty characteristic based on whether at least one of the characteristics would cause the automatic appraisal to fail;
prompting an interface in response to detecting the faulty characteristic;
receiving through the interface a first input addressing the faulty characteristic to produce a clean characteristic set;
executing the automatic appraisal of the subject property based on the clean characteristic set; and
providing a valuation of the subject property resulting from the automatic appraisal.

10. The medium of claim 9, further comprising:
receiving an identifier;
identifying, as the identified subject property, a real property to be automatically appraised based on the identifier; and
acquiring the plurality of electronic appraisals associated with the identified subject property.

11. The medium of claim 9, wherein
each of the plurality of electronic appraisals includes a set of data fields,
each of the data fields stores a characteristic corresponding to the subject property,
extracting the characteristics includes accumulating and grouping according to respective data fields each characteristic from the plurality of electronic appraisals, and
the faulty characteristics is a characteristic that is missing from each of the plurality of electronic appraisal across a same data field.

12. The medium of claim 9, wherein
the interface includes a set of data entry fields, each of which are configured to receive the at least one input,
one of the data entry fields is a primary data entry field, and
another of the data fields is a secondary data entry field that is linked to the primary data entry field.

13. The medium of claim 9, wherein
the clean characteristic set includes the faulty characteristic that has been addressed by the first input and the characteristics that were unaltered by the input.

14. The medium of claim 9, wherein
the automatic appraisal is an electronic pseudo appraisal that concentrates on a particular subset of the characteristics.

15. The medium of claim 14, wherein
the particular subset of the characteristics is defined by a predetermined configuration that sets a minimum number of characteristic groups that must be extracted for the automatic appraisal to proceed without fail.

16. The medium of claim 9, further comprising:
identifying, by a heuristic, a pattern relating to the faulty characteristic;
preventing of the prompting of the interface; and
proceeding with the automatic appraisal.
